(19) United States
(12) Patent Application Publication
(10) Pub. No.: US 2026/0285115 A1
(43) Pub. Date: Sep. 24, 2026

(54) HYDRAULIC SHOCK ABSORBER

(71) Applicant: Astemo, Ltd., Tokyo (JP)

(72) Inventor: Taiji FUKAZAWA, Hitachinaka-shi (JP)

(73) Assignee: Astemo, Ltd., Tokyo (JP)

(21) Appl. No.: 19/167,816

(22) PCT Filed: May 25, 2023
(86) PCT No.: PCT/JP2023/019453

§ 371 Date: Sep. 22, 2025

(51) Int. Cl. B60G 17/08; B60G 13/08

(52) U.S. Cl. CPC B60G 17/08; B60G 13/08; B60G 2202/24; B60G 2204/62; B60G 2206/41; B60G 2500/104; B60G 2500/11; B60G 2800/162; B60G 2800/916

(57) ABSTRACT

A hydraulic shock absorber includes a control valve that applies flow path resistance to hydraulic oil flowing from an opening of a rod to a reservoir, and a guide member that guides the hydraulic oil introduced from the opening to the control valve. The control valve includes a valve body located on a center line of the rod and displaced along the center line. The guide member is located between an upper end of the rod and the control valve and on the center line. An oil inlet of the guide member is located radially outside an outer peripheral surface of the rod and can introduce the hydraulic oil from the opening.

### CROSS-REFERENCE TO RELATED PATENT APPLICATIONS

This application is a U.S. National Phase Application under 35 U.S.C. § 371 of International Patent Application No. PCT/JP2023/019453 filed on May 25, 2023, the content of which is incorporated herein by reference in its entirety. The International Patent Application was published in Japanese on Nov. 28, 2024 as International Publication No. WO/2024/24156 under PCT Article 21(2).

### FIELD OF THE INVENTION

The present invention relates to a hydraulic shock absorber that is particularly suitable for use in a straddle-type vehicle on which a rider straddles.

### BACKGROUND OF THE INVENTION

A hydraulic shock absorber in which a vehicle body side tube and a wheel side tube are configured as a telescopic type is used for a suspension device mounted on a straddle-type vehicle such as a two-wheeled vehicle or a three-wheeled vehicle. For example, a hydraulic shock absorber in which a cylinder is provided in a wheel side tube, a rod that supports a piston in sliding contact with the cylinder is provided in a vehicle body side tube, and a control valve is provided in an upper portion of a vehicle body side tube is known from JP5452434B and JP2017-180689A.

In the hydraulic shock absorbers disclosed in JP5452434B and JP2017-180689A, a passage having an opening at an upper end of the rod and a lower opening in the cylinder is formed inside the rod, and the control valve is provided on an upper portion of the vehicle body side tube. The control valve applies flow path resistance to hydraulic oil flowing from the opening at an upper end of the passage to a reservoir. A damping force of the hydraulic shock absorber can be adjusted by adjusting opening and closing of the control valve.

### CITATION LIST

### Patent Literature

Patent Literature 1: JP5452434B
Patent Literature 2: JP2017-180689A

In the hydraulic shock absorber known in JP5452434B, a valve body of the control valve is located directly above the opening at the upper end of the rod and is displaced along a center line of the rod. The hydraulic oil discharged upward from the opening at the upper end of the rod directly hits the valve body. The flow of the hydraulic oil changes (that is, pulsates) according to an expansion and contraction operation of the hydraulic shock absorber. Since a flow velocity of the hydraulic oil discharged from the opening constantly changes, a discharge pressure of the hydraulic oil also constantly fluctuates. To prevent the fluctuation of the discharge pressure from affecting an operation of the control valve leads to stability of a control of the damping force by the control valve.

On the other hand, in the hydraulic shock absorber known in JP2017-180689A, the valve body of the control valve is located at the upper end of the rod, but is disposed obliquely with respect to the center line of the rod. Therefore, the hydraulic oil discharged upward from the opening at the upper end of the rod does not directly hit the valve body. The fluctuation of the discharge pressure can prevent an influence on the operation of the control valve. As a result, it is possible to improve stability of the control of the damping force by the control valve. However, in the hydraulic shock absorber, since the control valve is obliquely disposed, the configuration is inevitably complicated, which is disadvantageous in reducing cost and also disadvantageous in reducing the size of the hydraulic shock absorber in a radial direction.

An object of the present invention is to provide a technique capable of improving stability of a control of a damping force by a control valve of a hydraulic shock absorber including the control valve, and reducing cost and a size of the hydraulic shock absorber.

### SUMMARY OF THE INVENTION

As a result of intensive studies, the present inventors have focused on the fact that a discharge direction of hydraulic oil discharged from an upper portion of a tubular rod can be changed. Then, it has been found that a flow direction of the discharged hydraulic oil can be guided in a direction that does not affect an operation of a control valve without tilting the control valve. The present invention was completed based on these findings.

According to the present disclosure, there is provided a hydraulic shock absorber including: a telescopic type vehicle body side tube and a telescopic type wheel side tube respectively disposed on a vehicle body side and a wheel side; a cylinder extending from a lower end portion of the wheel side tube to an inside of the vehicle body side tube; a reservoir partitioned outside the cylinder and configured to store hydraulic oil; a rod extending from an upper end portion of the vehicle body side tube to an inside of the cylinder, the rod being a tubular member configured to allow the hydraulic oil to pass therethrough, and the rod having, at an upper portion thereof, an opening configured to allow the hydraulic oil to be discharged radially outside; a piston provided at a lower end portion of the rod and partitioning the inside of the cylinder into two oil chambers; a control valve provided at the upper end portion of the vehicle body side tube, including a valve body that is located on a center line of the rod and displaceable along the center line, and configured to apply flow path resistance to the hydraulic oil flowing from the opening of the rod to the reservoir by a displacement of the valve body; and a guide member located between an upper end of the rod and the control valve and on the center line of the rod, and including an oil inlet located radially outside an outer peripheral surface of the rod and configured to introduce the hydraulic oil from the opening of the rod, an oil outlet configured to lead out the hydraulic oil to the control valve, and a first guide path that guides the hydraulic oil introduced from the oil inlet to the oil outlet.

In the present disclosure, it is possible to provide a technique capable of improving stability of a control of the damping force by the control valve of the hydraulic shock absorber including the control valve, and reducing cost and a size of the hydraulic shock absorber.

### BRIEF DESCRIPTION OF THE DRAWINGS

FIG. 1 is a cross-sectional side view of a main part of a hydraulic shock absorber according to Embodiment 1.

FIG. 2 is a schematic diagram of a hydraulic circuit of the hydraulic shock absorber illustrated in FIG. 1.

FIG. 3 is an enlarged view of part 3 of FIG. 1.

FIG. 4 is an enlarged view of part 4 of FIG. 3.

FIG. 5A is an exploded perspective view of an upper end portion of a rod, a check valve, and a guide member illustrated in FIG. 4.

FIG. 5B is a cross-sectional view of the guide member taken along an arrow line 5B-5B in FIG. 5A.

FIG. 5C is a cross-sectional view of the guide member taken along an arrow line 5C-5C in FIG. 5A.

FIG. 5D is a perspective view of another example of an opening illustrated in FIG. 5A.

FIG. 6 is a view illustrating a flow of hydraulic oil from the rod to a valve accommodating portion illustrated in FIG. 4.

FIG. 7 is a view illustrating a flow of the hydraulic oil from the valve accommodating portion illustrated in FIG. 4 to a reservoir.

FIG. 8 is a cross-sectional view around a guide member and a control valve of a hydraulic shock absorber according to Embodiment 2.

FIG. 9A is a cross-sectional view of the guide member illustrated in FIG. 8.

FIG. 9B is a perspective view of the guide member viewed from a direction of an arrow line 9B in FIG. 9A.

FIG. 9C is a perspective view of the guide member viewed from a direction of an arrow line 9C in FIG. 9A.

### DETAILED DESCRIPTION OF THE INVENTION

Embodiments of the present invention will be described below with reference to the accompanying drawings. The embodiments illustrated in the accompanying drawings are examples of the present invention, and the present invention is not limited to the embodiments. In the description, upper and lower directions refer to upper and lower directions based on a state in which a hydraulic shock absorber is mounted on a straddle-type vehicle. Up in the drawings indicates an upper direction and Dn in the drawings indicates a lower direction.

### Embodiment 1

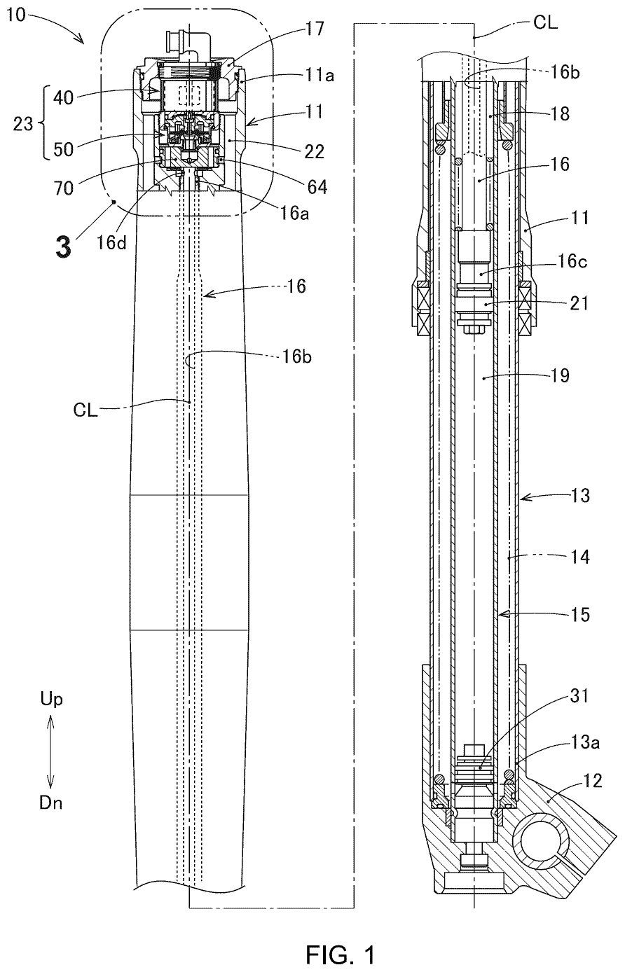

A hydraulic shock absorber 10 according to Embodiment 1 will be described with reference to FIGS. 1 to 7.

As illustrated in FIG. 1, the hydraulic shock absorber 10 is used in, for example, a vehicle, and as an example, is used in a motorcycle, which is a type of a straddle-type vehicle (not illustrated) on which a rider straddles. In the following, the motorcycle may be referred to as a “straddle-type vehicle” or a “vehicle”.

The hydraulic shock absorber 10 is a telescopic type and includes a cylindrical vehicle body side tube 11 (first tube 11) connected to a vehicle body side bracket (not illustrated) and a cylindrical axle side tube 13 (second tube 13) connected to an axle side bracket 12.

The axle side tube 13 is fitted so as to be movable relative to the vehicle body side tube 11. A coil spring 14 that biases the vehicle body side tube 11 and the axle side tube 13 in a direction away from each other is disposed inside the axle side tube 13.

Here, a stroke in which the hydraulic shock absorber 10 contracts is referred to as a compression stroke, and a stroke in which the hydraulic shock absorber 10 extends is referred to as an extension stroke. In Embodiment 1, the hydraulic shock absorber 10 described as having an inverted configuration in which the axle side tube 13 is advanced and retracted with respect to the vehicle body side tube 11. However, the hydraulic shock absorber 10 includes an upright configuration in which the vehicle body side tube 11 is advanced and retracted with respect to the axle side tube 13.

The hydraulic shock absorber 10 includes a cylinder 15 extending from a lower end portion 13a (for example, the axle side bracket 12) of the wheel side tube 13 to the inside of the vehicle body side tube 11, and a rod 16 extending from an upper end portion 11a of the vehicle body side tube 11 to the inside of the cylinder 15. The inside of the cylindrical cylinder 15 is filled with the hydraulic oil. The upper end portion 11a of the vehicle body side tube 11 is closed by, for example, a closing member 17 (cap member 17). The rod 16 is a tubular member, that is, a so-called hollow rod, through which the hydraulic oil can pass to interior 16b (internal flow path 16b). A lower end portion 16c of the rod 16 is provided with a piston 21 that partitions the inside of the cylinder 15 into two oil chambers 18, 19 (an upper first oil chamber 18 and a lower second oil chamber 19). The vehicle body side tube 11, the axle side tube 13, the cylinder 15, the rod 16, and the piston 21 are all located on the center line CL of the rod 16.

The hydraulic shock absorber 10 further includes a reservoir 22 defined outside the cylinder 15, and a damping force generating device 23 provided at the upper end portion 11a of the vehicle body side tube 11. The reservoir 22 is a space defined outside the cylinder 15 surrounded by the vehicle body side tube 11 and the axle side tube 13, and can store the hydraulic oil. The damping force generating device 23 is provided, for example, on the closing member 17 and is located on the center line CL of the rod 16. The damping force generating device 23 includes a control valve 50 whose opening area can be varied, and an actuator 40 that controls the control valve 50. The control valve 50 has a function of a variable throttle valve. Details of the damping force generating device 23 will be described later.

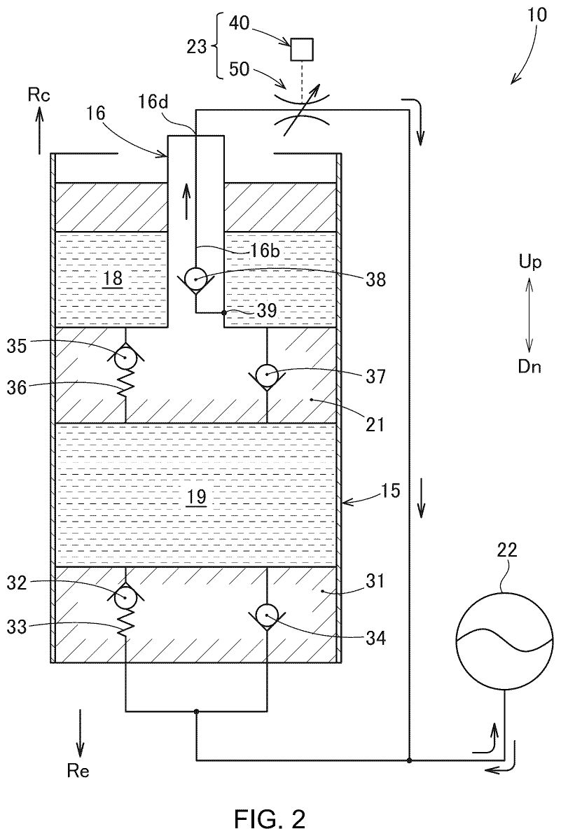

Here, the flow of the hydraulic oil in the hydraulic shock absorber 10 will be described with reference to FIG. 2. FIG. 2 illustrates a hydraulic circuit of the hydraulic shock absorber 10.

The cylinder 15 includes a base valve 31 at an end portion on an axle side. The base valve 31 includes a compression side damping valve 32, a compression side throttle flow path 33, and an extension side check valve 34. The compression side damping valve 32 can generate a damping force when the hydraulic oil flowing from the lower second oil chamber 19 to the reservoir 22 passes through the compression side throttle flow path 33 in the compression stroke of the hydraulic shock absorber 10. The extension side check valve 34 allows the hydraulic oil to flow from the reservoir 22 to the lower second oil chamber 19 in the extension stroke of the hydraulic shock absorber 10.

The piston 21 includes an extension side damping valve 35, an extension side throttle flow path 36, and a compression side check valve 37. The extension side damping valve 35 can generate a damping force when the hydraulic oil flowing from the upper first oil chamber 18 to the lower second oil chamber 19 passes through the extension side throttle flow path 36 in the extension stroke of the hydraulic shock absorber 10. The compression side check valve 37 allows the flow of the hydraulic oil from the second oil chamber 19 to the first oil chamber 18 in the compression stroke of the hydraulic shock absorber 10.

The rod 16 has an opening 16d capable of discharging the hydraulic oil in an upper end portion 16a. Further, the rod 16 includes a flow straightening device 38 having a check valve structure. Only when a pressure in the upper first oil chamber 18 is higher than a pressure in the reservoir 22, the flow straightening device 38 allows the hydraulic oil to flow from the first oil chamber 18 into the internal flow path 16b of the rod 16 via an inflow path 39.

When the hydraulic shock absorber 10 is in the extension stroke (when the cylinder 15 extends in an arrow Re direction with respect to the piston 21), a volume of the upper first oil chamber 18 decreases, and a volume of the lower second oil chamber 19 increases. The pressure in the first oil chamber 18 is higher than the pressure in the reservoir 22. The flow straightening device 38 of the rod 16 allows the flow of the hydraulic oil from the first oil chamber 18 toward the internal flow path 16b of the rod 16. The hydraulic oil in the first oil chamber 18 passes through the internal flow path 16b of the rod 16, is discharged from the opening 16d, and flows out to the reservoir 22 via the control valve 50. When the control valve 50 applies flow path resistance to the hydraulic oil, a damping effect occurs. A part of the surplus hydraulic oil in the first oil chamber 18 passes through a damping valve 28 and flows out to the second oil chamber 19. At this time, the damping effect by the extension side throttle flow path 36 occurs. The hydraulic oil stored in the reservoir 22 flows into the second oil chamber 19 having the increased volume through the check valve 33.

When the hydraulic shock absorber 10 is in the compression stroke (when the cylinder 15 contracts in an arrow Rc direction with respect to the piston 21), the volume of the upper first oil chamber 18 increases, and the volume of the lower second oil chamber 19 decreases. The hydraulic oil in the second oil chamber 19 flows out to the reservoir 22 through the compression side damping valve 32. At this time, the damping effect is generated by the compression side throttle flow path 33. However, the flow path resistance of the hydraulic oil passing through the compression side throttle flow path 33 is larger than the flow path resistance of the hydraulic oil passing through a check valve 30. Therefore, a part of the hydraulic oil in the second oil chamber 19 flows into the first oil chamber 18 via the check valve 30.

As the hydraulic oil flowing from the second oil chamber 19 into the first oil chamber 18 increases, the pressure in the first oil chamber 18 becomes higher than the pressure in the reservoir 22. When the pressure in the first oil chamber 18 becomes higher than the pressure in the reservoir 22, the flow straightening device 38 of the rod 16 allows the flow of the hydraulic oil from the first oil chamber 18 toward the internal flow path 16b of the rod 16. The hydraulic oil in the first oil chamber 18 passes through the internal flow path 16b of the rod 16, is discharged from the opening 16d, and flows out to the reservoir 22 via the control valve 50. When the control valve 50 applies the flow path resistance to the hydraulic oil, the damping effect occurs.

As is clear from the above description, in both the compression stroke and the extension stroke of the hydraulic shock absorber 10, the hydraulic oil in the first oil chamber 18 passes through the internal flow path 16b of the rod 16, is discharged from the opening 16d, and flows out to the reservoir 22 via the control valve 50. When the control valve 50 applies the flow path resistance to the hydraulic oil, a damping effect occurs in the hydraulic shock absorber 10.

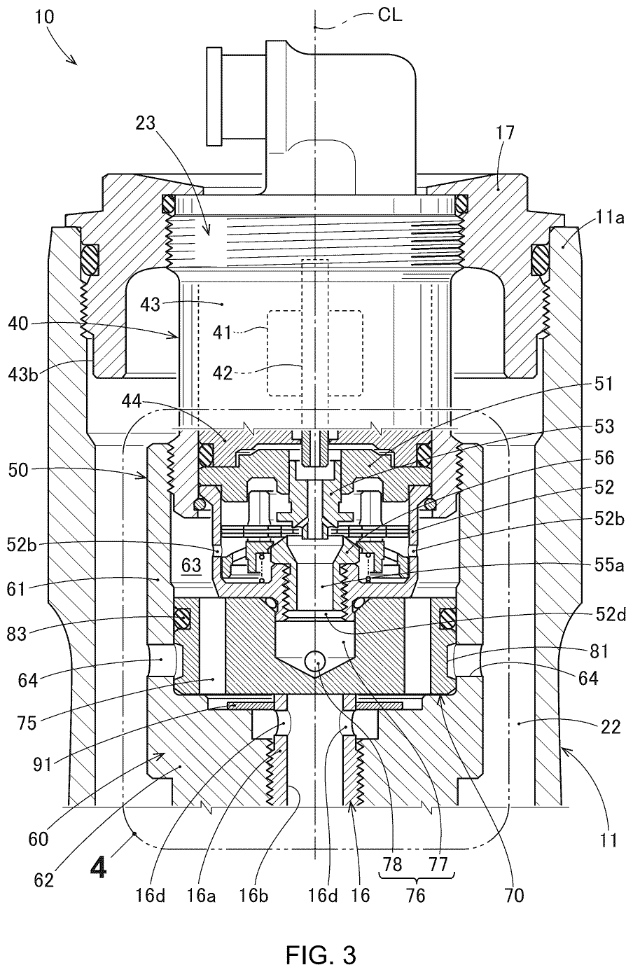

Next, the damping force generating device 23 will be described in detail. FIG. 3 illustrates the damping force generating device 23 provided in an upper portion of the vehicle body side tube 11.

The actuator 40 and the control valve 50 of the damping force generating device 23 are located on the center line CL of the rod 16. The actuator 40 is preferably configured with an electromagnetic solenoid including an actuation rod 42. The actuator 40 may be referred to as an “electromagnetic solenoid 40” as appropriate.

The electromagnetic solenoid 40 (actuator 40) is a so-called proportional solenoid in which an amount of current supplied to an excitation coil (not illustrated) is proportional to an advancing distance (advancing/retracting amount) of a plunger 41. Further, the electromagnetic solenoid 40 is constituted by a push-type solenoid that moves the plunger 41 forward by excitation of the excitation coil. The plunger 41 includes the actuation rod 42 (valve rod 42) located on the center line CL of the rod 16. The valve rod 42 can advance and retreat in a direction along the center line CL of the rod 16 together with the plunger 41. As described above, since the electromagnetic solenoid 40 is a proportional solenoid, an opening degree of the control valve 50 can be adjusted according to the advancing distance of the plunger 41 and the valve rod 42.

A housing 43 of the electromagnetic solenoid 40 accommodates the excitation coil and the plunger 41. By attaching the upper end portion of the housing 43 to the closing member 17, the electromagnetic solenoid 40 can be attached to the upper end portion 11a of the vehicle body side tube 11. The housing 43 of the electromagnetic solenoid 40 may be referred to as an “actuator housing 43” or a “first housing 43” as appropriate. An opening at the lower end of the first housing 43 is closed by a lid 44. The lid 44 is fixed to the first housing 43.

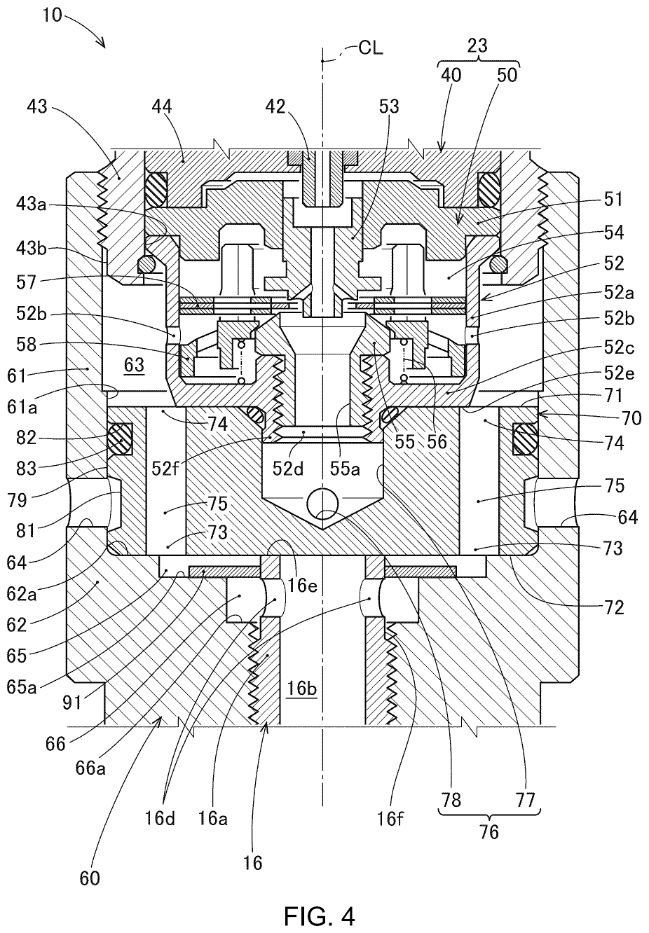

As illustrated in FIG. 4, the control valve 50 is detachably attached to a lower end of an inner peripheral surface 43a of the first housing 43. The control valve 50 includes a valve body holder 51 disposed below the lid 44 of the actuator 40, and a bottomed tubular valve housing 52 disposed below the valve body holder 51. The valve body holder 51 holds the valve body 53 located on the center line CL of the rod 16. The valve body 53 is movable along the center line CL by being pushed by the valve rod 42.

The valve housing 52 may be referred to as a “second housing 52” as appropriate. The second housing 52 is detachably attached to the lower end of the inner peripheral surface 43a of the first housing 43 together with the valve body holder 51. An opening at an upper end of the second housing 52 is closed by the valve body holder 51. A valve accommodating portion 54 (accommodating space 54) is defined inside by the valve body holder 51 and the second housing 52.

A side wall 52a of the second housing 52 has a cylindrical shape with respect to the center line CL of the rod 16. The side wall 52a has at least one first opening 52b penetrating therethrough to allow communication between the valve accommodating portion 54 and the outside.

A bottom plate 52c of the second housing 52 has a flat plate shape orthogonal to the center line CL of the rod 16. The bottom plate 52c has a second opening 52d penetrating therethrough to allow communication between the valve accommodating portion 54 and the outside. The second opening 52d is located on the center line CL of the rod 16. Further, the bottom plate 52c of the second housing 52 includes a valve seat 55 facing the valve body 53. The valve seat 55 has a through hole 55a penetrating vertically. The through hole 55a communicates the valve accommodating portion 54 with the second opening 52d.

The opening degree of the control valve 50 changes according to a movement amount of the valve body 53 with respect to the valve seat 55. An amount of damping force generated by the control valve 50 can be adjusted by adjusting the movement amount of the valve body 53 by the electromagnetic solenoid 40. The valve body 53 is biased by a coil spring 56 in a direction away from the valve seat 55.

As illustrated in FIG. 4, the control valve 50 may be configured to adjust the amount of damping force generated via a plurality of plate-shaped valve plates 57 stacked in the direction along the center line CL of the rod 16. However, the presence or absence of the valve plate 57 is any.

The plurality of valve plates 57 are arranged at predetermined intervals in the direction along the center line CL of the rod 16. In FIG. 4, the intervals between the valve plates 57 are not illustrated. Each valve plate 57 is elastically deformable in the direction along the center line CL. When the valve body 53 moves in the direction along the center line CL and pushes each valve plate 57 toward the valve seat 55, the interval between the valve plates 57 decreases. By changing the interval between the valve plates 57 by adjusting the movement amount of the valve body 53, the amount of damping force generated by the control valve 50 can be adjusted. Each valve plate 57 is biased by the coil spring 56 in a direction away from the valve seat 55 via a valve holding portion 58.

As illustrated in FIG. 3, a bottomed tubular rod holder 60 is detachably attached to a lower end of an outer peripheral surface 43b of the first housing 43. The rod holder 60 is located inside the first tube 11 together with the first housing 43. The side wall 61 of the rod holder 60 has a cylindrical shape with respect to the center line CL of the rod 16. A bottom plate 62 of the rod holder 60 has a flat disk shape orthogonal to the center line CL of the rod 16. A valve accommodating portion 63 (accommodating chamber 63) is defined inside by the lid 44 and the rod holder 60. The control valve 50 is accommodated in the valve accommodating portion 63. The first opening 52b of the second housing 52 of the control valve 50 communicates with the valve accommodating portion 63.

The side wall 61 of the rod holder 60 has at least one communication hole 64 penetrating therethrough. The communication hole 64 communicates between the reservoir 22 in the first tube 11 and the valve accommodating portion 63.

The upper end portion 16a of the rod 16 is detachably attached to the bottom plate 62 of the rod holder 60. As a result, the upper end portion 16a of the rod 16 is attached to the upper end portion 11a of the vehicle body side tube 11 by the closing member 17, the first housing 43, and the rod holder 60.

As illustrated in FIG. 4, the opening 16d located at the upper end portion 16a of the rod 16 penetrates in the radial direction of the rod 16. Therefore, the hydraulic oil flowing through the internal flow path 16b of the rod 16 can be discharged radially outside from the opening 16d.

A guide member 70 that guides the hydraulic oil is disposed between an upper end 16e (upper end surface 16e) of the rod 16 and the control valve 50. The guide member 70 is accommodated in the valve accommodating portion 63, is located on the center line CL of the rod 16, and is sandwiched between the bottom plate 52c of the second housing 52 and the bottom plate 62 of the rod holder 60. The guide member 70 has a disk shape that can be fitted to an inner peripheral surface 61a of the side wall 61 of the rod holder 60.

Both end surfaces 71, 72 (an upper first end surface 71 and a lower second end surface 72) of the guide member 70 are flat surfaces orthogonal to the center line CL of the rod 16. On the other hand, a bottom surface 52e of the bottom plate 52c of the second housing 52 and an inner bottom surface 62a of the bottom plate 62 of the rod holder 60 are also flat surfaces orthogonal to the center line CL of the rod 16. Therefore, both end surfaces 71, 72 of the guide member 70 are in close contact with the bottom surface 52e and the inner bottom surface 62a. The upper end surface 16e of the rod 16 is closed by the second end surface 72 of the guide member 70 by being in close contact with the second end surface 72.

Recesses 65, 66 recessed in two stages along the center line CL of the rod 16 is formed in the bottom surface 62a of the bottom plate 62 of the rod holder 60. These recesses 65, 66 have a circular shape with respect to the center line CL. In a state in which the upper end surface 16e of the rod 16 is in contact with the second end surface 72 of the guide member 70, the bottom surface 65a of the upper first recess 65 located directly below the bottom surface 52e is at least located at an upper position than the opening 16d of the rod 16. A diameter of the first recess 65 is preferably larger than a diameter of the second housing 52. Further, in a state in which the upper end surface 16e of the rod 16 is in contact with the second end surface 72 of the guide member 70, the bottom surface 66a of the lower second recess 66 located directly below the first recess 65 is at least located at a lower position than the opening 16d of the rod 16. A diameter of the second recess 66 is smaller than the diameter of the first recess 65.

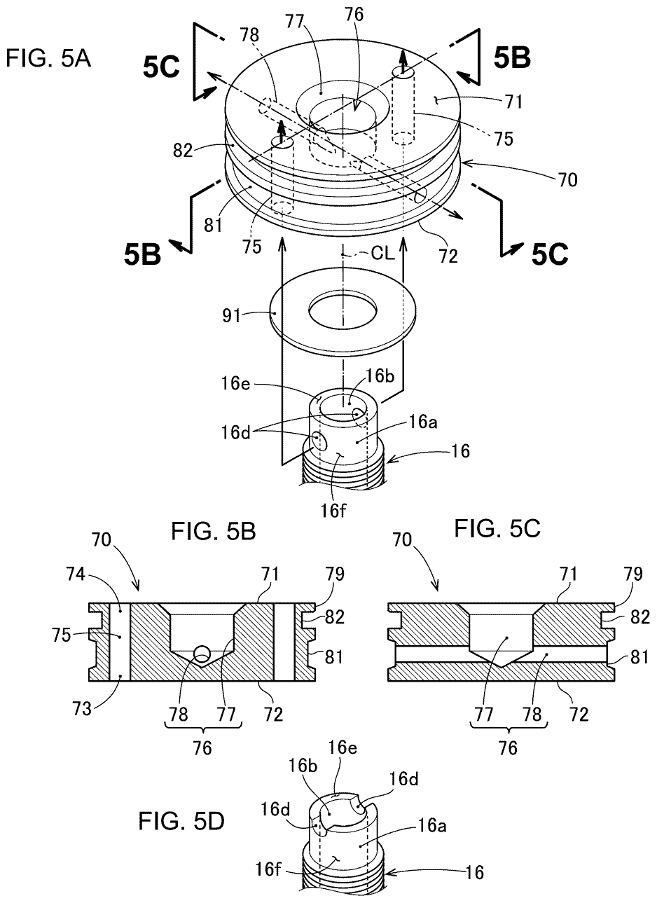

As illustrated in FIG. 4 and FIG. 5A to FIG. 5C, the guide member 70 includes oil inlets 73, oil outlets 74, first guide paths 75 communicating from the oil inlets 73 to the oil outlets 74, and a second guide path 76 separated from the first guide paths 75.

The oil inlet 73 is located radially outside an outer peripheral surface 16f of the rod 16, and can introduce the hydraulic oil from the opening 16d of the rod 16. That is, the oil inlet 73 opens to the lower second end surface 72 and communicates with the first recess 65. The oil outlet 74 is capable of leading out the hydraulic oil to the control valve 50 and is located radially outside the control valve 50. That is, it is preferable that the oil outlet 74 communicates with the valve accommodating portion 63 and is located radially outside the second housing 52. The first guide path 75 can guide the hydraulic oil introduced from the oil inlet 73 to the oil outlet 74. The first guide path 75 extends in the longitudinal direction of the rod 16 (for example, the direction along the center line CL of the rod 16).

The second guide path 76 can guide the hydraulic oil flowing from the control valve 50 to the reservoir 22, and is separated from the first guide path 75. For example, the second guide path 76 includes a vertical hole-shaped first hole 77 located on the center line CL of the rod 16 and a horizontal hole-shaped second hole 78 intersecting the center line CL from the first hole 77. The first hole 77 is configured to open the control valve 50 side and close the lower second end surface 72 side. The first hole 77 communicates with the second opening 52d of the second housing 52. At least a part of the control valve 50, for example, a protruding portion 52f protruding downward from the bottom plate 52c of the second housing 52 is fitted into the first hole 77 of the guide member 70. The second hole 78 extends toward an outer peripheral surface 79 of the guide member 70. Thus, the second guide path 76 extends in the radial direction of the rod 16.

The guide member 70 includes an annular groove 81 and a seal groove 82 formed over the entire circumference of the outer peripheral surface 79. The annular groove 81 is located close to the lower second end surface 72 and communicates with the second guide path 76. The seal groove 82 is located close to the upper first end surface 71, and a seal member 83 such as an O-ring is fitted therein. The seal member 83 can seal between the accommodating chamber 63 accommodating the control valve 50 and the reservoir 22.

As illustrated in FIG. 4 and FIG. 5A, a hollow disk-shaped check valve 91 is disposed in the upper first recess 65. The check valve 91 is fitted to the upper end portion 16a of the rod 16 so as to be relatively movable, is placed on the bottom surface 65a of the first recess 65, and allows only the flow of the hydraulic oil flowing from the opening 16d of the rod 16 to the control valve 50. That is, in a normal state in which the hydraulic oil is not discharged from the opening 16d of the rod 16 (for example, while the actuator 40 is stopped), the check valve 91 is placed on the bottom surface 65a by its own weight to close the lower second recess 66. On the other hand, in a state in which the hydraulic oil is discharged from the opening 16d, the hydraulic oil pushes up the check valve 91 to open the second recess 66.

The configuration of the opening 16d of the rod 16 illustrated in FIG. 5A is not limited to a round hole, and may be, for example, as illustrated in FIG. 5D, a notch extending to the upper end surface 16e of the rod 16.

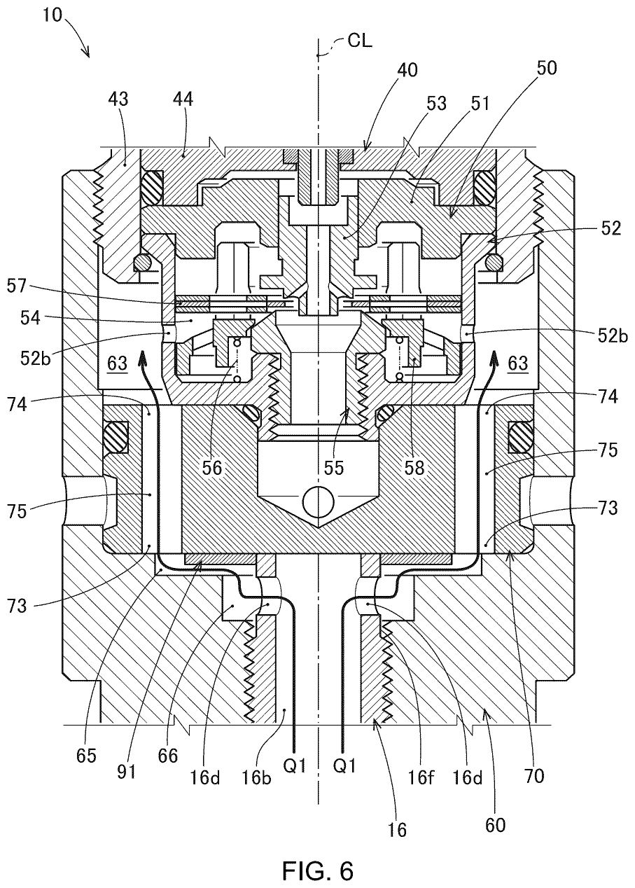

Next, the flow of the hydraulic oil from the rod 16 to the reservoir 22 will be described. As illustrated in FIG. 6, the hydraulic oil flowing through the internal flow path 16b of the rod 16 flows in an arrow Q1 direction. That is, the hydraulic oil flowing through the internal flow path 16b is discharged from the opening 16d of the rod 16, enters the lower second recess 66, pushes up the check valve 91, enters the upper first recess 65, and enters the oil inlet 73. Further, the hydraulic oil passes through the first guide path 75 from the oil inlet 73, flows out from the oil outlet 74, and enters the valve accommodating portion 63.

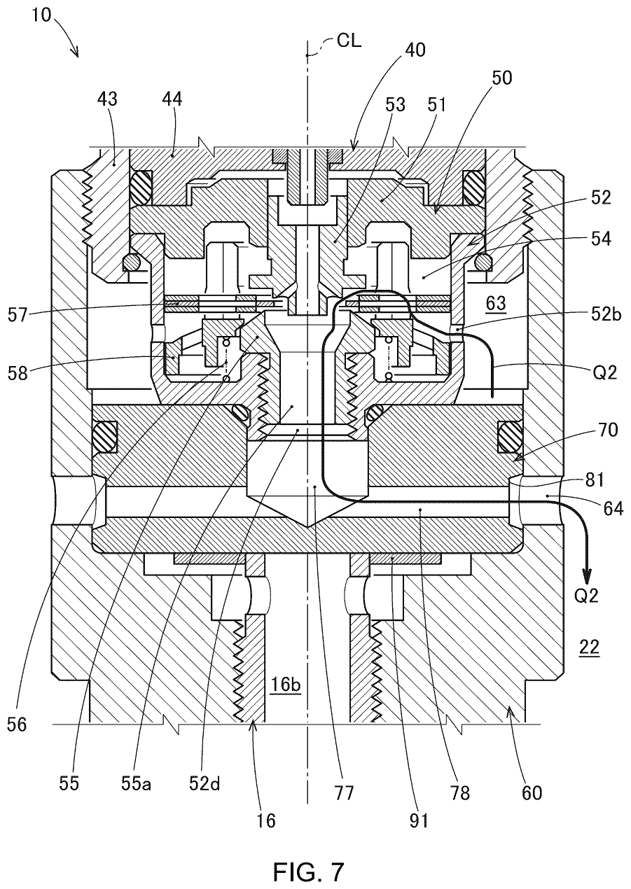

As illustrated in FIG. 7, the hydraulic oil that has entered the valve accommodating portion 63 flows in an arrow Q2 direction. That is, the hydraulic oil is given the flow path resistance as the hydraulic oil passes between the valve body 53 and the valve seat 55, passes through the through hole 55a of the valve seat 55 and the second opening 52d of the second housing 52, and then enters the second guide path 76. Further, the hydraulic oil flows from the first hole 77 through the second hole 78 of the second guide path 76 and flows out from the annular groove 81 of the guide member 70 to the reservoir 22.

### Embodiment 2

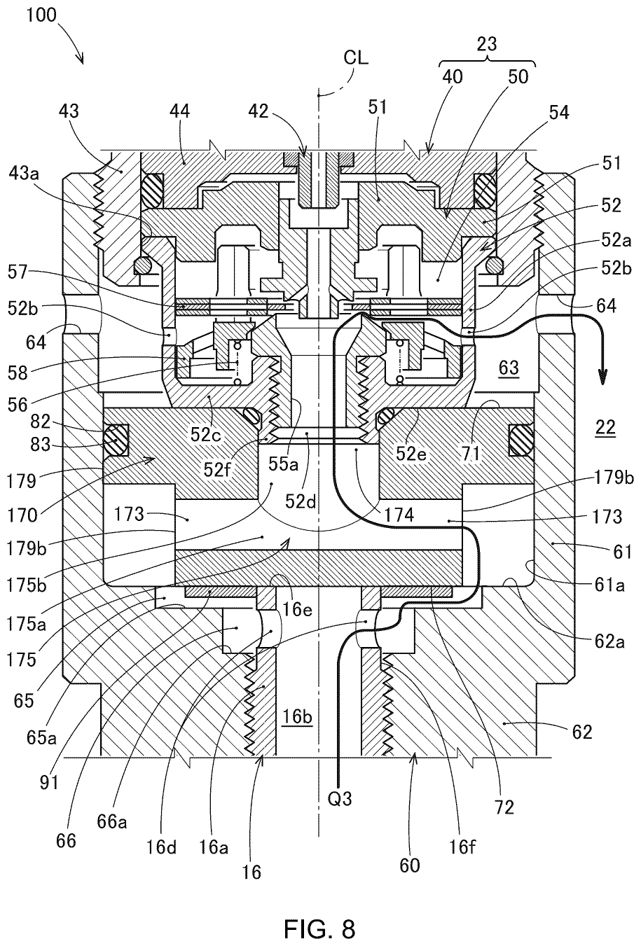

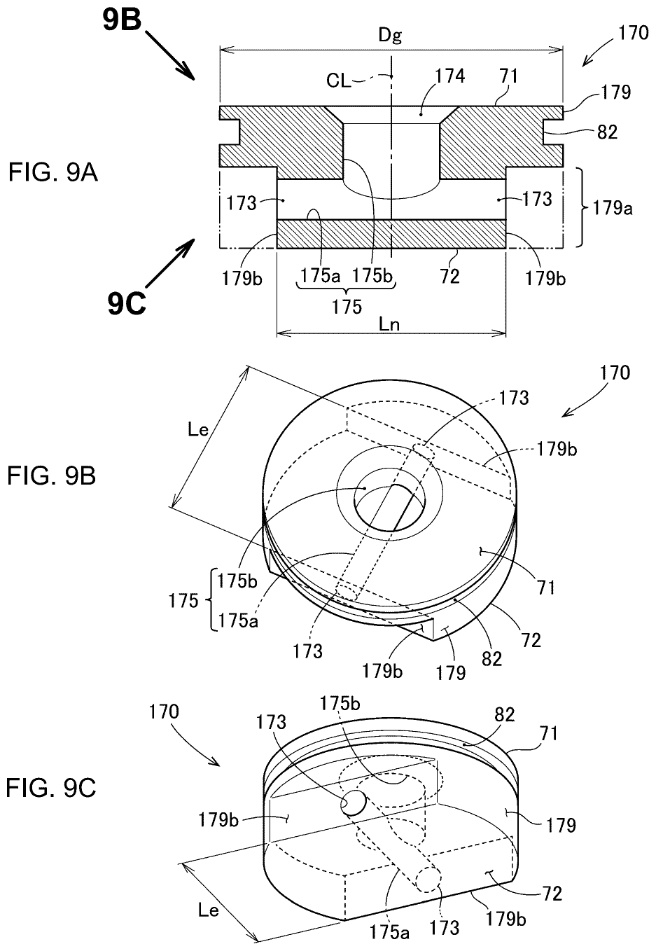

A hydraulic shock absorber 100 according to Embodiment 2 will be described with reference to FIGS. 8, 9A, 9B and 9C.

FIG. 8 is a cross-sectional view illustrating the hydraulic shock absorber 100 according to Embodiment 2, and corresponds to FIG. 4 illustrating the hydraulic shock absorber 10 according to Embodiment 1. The hydraulic shock absorber 100 according to Embodiment 2 is characterized in that the guide member 70 according to Embodiment 1 illustrated in FIG. 4 is changed to a guide member 170 illustrated in FIGS. 8, 9A, 9B and 9C. Other basic configurations are the same as those of the hydraulic shock absorber 10 according to Embodiment 1. Components common to the hydraulic shock absorber 10 according to Embodiment 1 are denoted by the same reference numerals, and detailed description thereof is omitted.

In the guide member 170 according to Embodiment 2, a part of a lower half 179a (a portion 179a on the lower second end surface 72 side) of an outer peripheral surface 179 along the center line CL of the rod 16 is cut out. As a result, a pair of end surfaces 179b, 179b are formed in the lower half 179a of the guide member 170. These end surfaces 179b, 179b are flat surfaces parallel to the center line CL and face each other with respect to the center line CL. A distance Le between the end surfaces 179b, 179b is smaller than a diameter Dg of the guide member 170.

The guide member 170 according to Embodiment 2 includes a pair of oil inlets 173, 173, an oil outlet 174, and a first guide path 175 communicating from the oil inlets 173 to the oil outlet 174. The guide member 170 according to Embodiment 2 does not need to include the second guide path 76 included in the guide member 70 according to Embodiment 1 illustrated in FIG. 4.

The pair of oil inlets 173, 173 open in the pair of end surfaces 179b, 179b, respectively, are located radially outside the outer peripheral surface 16f of the rod 16, and can introduce the hydraulic oil from the opening 16d of the rod 16. The oil outlet 174 can lead out the hydraulic oil to the control valve 50, and is located on the center line CL of the rod 16. That is, the oil outlet 174 communicates with the through hole 55a of the valve seat 55. The first guide path 175 includes a horizontal hole-shaped first passage 175a extending from the oil inlets 173, 173 in the direction intersecting the center line CL of the rod 16, and a vertical hole-shaped second passage 175b extending from the first passage 175a to the oil outlet 174. The second passage 175b is located on the center line CL of the rod 16.

Next, the flow of hydraulic oil from the rod 16 to the reservoir 22 in Embodiment 2 will be described. As illustrated in FIG. 8, the hydraulic oil flowing through the internal flow path 16b of the rod 16 flows in an arrow Q3 direction. That is, the hydraulic oil flowing through the internal flow path 16b is discharged from the opening 16d of the rod 16, enters the lower second recess 66, pushes up the check valve 91, enters the upper first recess 65, and enters the oil inlet 173. Further, the hydraulic oil passes through the first guide path 175 from the oil inlets 173, flows out from the oil outlet 174, and enters the through hole 55a of the valve seat 55.

The hydraulic oil that has entered the through hole 55a is given the flow path resistance as the hydraulic oil passes between the valve body 53 and the valve seat 55, passes through the first opening 52b of the second housing 52 and the valve accommodating portion 63, and then flows out from the communication hole 64 of the rod holder 60 to the reservoir 22.

The operation and effect of the hydraulic shock absorber 100 according to Embodiment 2 are the same as those of the hydraulic shock absorber 10 according to Embodiment 1.

The hydraulic shock absorbers 10, 100 described above are summarized as follows. Reference is made to FIGS. 1 and 8. (1) According to the present embodiment, the hydraulic shock absorbers 10, 100 each include the telescopic type vehicle body side tube 11 and the telescopic type wheel side tube 13 disposed on the vehicle body side and the wheel side, respectively, the cylinder 15 extending from the lower end portion 13a of the wheel side tube 13 to the inside of the vehicle body side tube 11, and the reservoir 22 partitioned outside the cylinder 15 and capable of storing the hydraulic oil.

Reference is made to FIG. 1. The hydraulic shock absorbers 10, 100 each include the rod 16 that extends from the upper end portion 11a of the vehicle body side tube 11 to the inside of the cylinder 15, is a tubular member configured to allow the hydraulic oil to pass therethrough, and has the opening 16d configured to allow the hydraulic oil to be discharged radially outside, at the upper portion thereof, and the piston 21 that is provided at the lower end portion 16c of the rod 16 and partitions the inside of the cylinder 15 into two oil chambers 18, 19.

Reference is made to FIGS. 1 and 3. The hydraulic shock absorbers 10, 100 each include the control valve 50 that is provided at the upper end portion 11a of the vehicle body side tube 11, includes the valve body 53 that is located on the center line CL of the rod 16 and displaceable along the center line CL, and applies the flow path resistance to the hydraulic oil flowing from the opening 16d of the rod 16 to the reservoir 22 by a displacement of the valve body 53.

Reference is made to FIGS. 4 and 8. The hydraulic shock absorbers 10, 100 include the guide members 70, 170, which are located between the upper end 16e (upper end surface 16e) of the rod 16 and the control valve 50 and on the center line CL of the rod 16, and include the oil inlets 73, 173 that are located radially outside the outer peripheral surface 16f and capable of introducing the hydraulic oil from the opening 16d of the rod 16, the oil outlets 74, 174 that can lead out the hydraulic oil to the control valve 50, and the first guide paths 75, 175 that guide the hydraulic oil introduced from the oil inlets 73, 173 to the oil outlets 74, 174.

As described above, since the tubular rod 16 has the opening 16d through which the hydraulic oil can be discharged radially outside at the upper portion, a discharge direction of the hydraulic oil discharged from the upper portion of the rod is changed to a radial outward direction from the upper end of the rod. The guide member 70 includes the first guide path 75 that guides the hydraulic oil discharged from the opening 16d of the rod 16 to the control valve 50. For example, the first guide path 75 can guide the hydraulic oil discharged from the opening 16d of the rod 16 to the control valve 50 while bypassing the hydraulic oil to the radially outside of the control valve 50. Therefore, even if the control valve 50 is not inclined with respect to the center line CL of the rod 16, a flow direction of the hydraulic oil discharged from the opening 16d of the rod 16 can be guided in the direction that does not affect the operation of the control valve 50. Therefore, stability of the control of the damping force by the control valve 50 of the hydraulic shock absorber 10 including the control valve 50 can be improved, and the cost and the size of the hydraulic shock absorber 10 can be reduced.

Reference is made to FIGS. 4 and 5A. (2) In the hydraulic shock absorber 10 according to (1), the guide member 70 preferably includes the second guide path 76 that guides the hydraulic oil flowing from the control valve 50 to the reservoir 22. The first guide path 75 extends in the longitudinal direction of the rod 16 (for example, the direction along the center line CL of the rod 16). The second guide path 76 extends in the radial direction of the rod 16 and is separated from the first guide path 75.

As described above, the second guide path 76 that guides the hydraulic oil from the control valve 50 to the reservoir 22 is separated from the first guide path 75 extending in the longitudinal direction of the rod 16 and extends in the radial direction of the rod 16. That is, the first guide path 75 and the second guide path 76 are independent of each other and have different guide directions of the hydraulic oil. Therefore, the second guide path 76 can be disposed within a range of the guide member 70 in a direction in which the first guide path 75 extends. Therefore, although the guide member 70 includes both the first guide path 75 and the second guide path 76, a length thereof in the direction in which the first guide path 75 extends can be prevented. By reducing the size of the guide member 70, the overall size of the hydraulic shock absorber 10 including the control valve 50 can be reduced.

Reference is made to FIG. 4. (3) In the hydraulic shock absorber 10 according to (1) and (2), the guide member 70 preferably includes the annular groove 81 formed over the entire circumference of the outer peripheral surface 79. The annular groove 81 communicates with the second guide path 76. Therefore, the hydraulic oil can be guided from the control valve 50 to the reservoir 22 regardless of an orientation of the second guide path 76 with respect to the center line CL of the rod 16. Therefore, ease of assembling the guide member 70 to the hydraulic shock absorber 10 can be improved.

Reference is made to FIG. 4. (4) In the hydraulic shock absorber 10 according to (2) and (3), the oil outlet 74 is preferably located radially outside the control valve 50. Therefore, the hydraulic oil discharged from the opening 16d of the rod 16 can be guided to the control valve 50 while bypassing the hydraulic oil to the radially outside of the control valve 50. The stability of the control of the damping force by the control valve 50 can be further improved.

Reference is made to FIG. 4. (5) In the hydraulic shock absorber 10 according to (1) to (4), the guide member 70 preferably includes the seal member 83 that seals between the accommodating chamber 63 accommodating the control valve 50 and the reservoir 22. Therefore, the seal member 83 can restrict the hydraulic oil not controlled by the control valve 50 from leaking from the accommodating chamber 63 to the reservoir 22. The stability of the control of the damping force by the control valve 50 can be further improved.

Reference is made to FIGS. 4 and 8. (6) In the hydraulic shock absorbers 10, 100 according to (1) to (5), at least a part of the control valve 50 (the protruding portion 52f of the second housing 52) is preferably fitted into the guide member 70. Therefore, the guide member 70 can be easily positioned with respect to the control valve 50. Moreover, since the control valve 50 is fitted into the guide member 70, an axial length of the hydraulic shock absorber 10 can be shortened.

Reference is made to FIGS. 4 and 8. (7) In the hydraulic shock absorber 10 according to (1) to (6), the hydraulic shock absorbers 10, 100 preferably each include the check valve 91 that allows only the flow of the hydraulic oil flowing from the opening 16d of the rod 16 to the control valve 50. Therefore, when the hydraulic oil does not flow from the opening 16d to the control valve 50, the check valve 91 is closed, so that the hydraulic oil accumulated in the control valve 50 can be restricted from flowing out to the opening 16d side of the rod 16. Therefore, when the hydraulic oil flows from the opening 16d of the rod 16 to the control valve 50 next time, the control valve 50 can quickly control the damping force. As a result, the stability of the control of the damping force by the control valve 50 can be further improved.

Reference is made to FIG. 8. (8) In the hydraulic shock absorber 100 according to (1), the first guide path 175 preferably includes the horizontal hole-shaped first passage 175a extending from the oil inlet 173 in the direction intersecting the center line CL of the rod 16, and the vertical hole-shaped second passage 175b extending from the first passage 175a to the oil outlet 174. The second passage 175b is located on the center line CL of the rod 16.

Therefore, the hydraulic oil discharged from the opening 16d of the rod 16 can be directed radially outside of the control valve 50 by the horizontal hole-shaped first passage 175a, and then guided to the control valve 50 by the vertical hole-shaped second passage 175b. That is, the flow direction of the hydraulic oil discharged from the opening 16d can be easily guided in the direction that does not affect the operation of the control valve 50. Therefore, the stability of the control of the damping force by the control valve 50 can be further improved.

The hydraulic shock absorbers 10, 100 according to the present invention are not limited to the embodiments described above as long as the operation and effect of the present invention are exhibited.

### INDUSTRIAL APPLICABILITY

The hydraulic shock absorbers 10, 100 according to the present invention are suitable for being mounted on a straddle-type vehicle.

### REFERENCE SIGNS LIST

10: hydraulic shock absorber
11: vehicle body side tube
11a: end portion
13: axle side tube
13a: lower end portion
15: cylinder
16: rod
16a: upper end portion
16b: interior (internal flow path)
16c: lower end portion
16d: opening
16f: outer peripheral surface
18: first oil chamber
19: second oil chamber
21: piston
22: reservoir
23: damping force generating device
40: actuator
50: control valve
53: valve body
55: valve seat
73: oil inlet
74: oil outlet
75: first guide path
76: second guide path
77: first hole
78: second hole
79: outer peripheral surface of guide member
81: annular groove
82: seal groove
83: seal member
91: check valve
100: hydraulic shock absorber
170: guide member
173: oil inlet
174: oil outlet
175: first guide path
175a: first passage
175b: second passage
179 outer peripheral surface
CL: center line of rod

1. A hydraulic shock absorber comprising:
a telescopic type vehicle body side tube and a telescopic type wheel side tube respectively disposed on a vehicle body side and a wheel side;
a cylinder extending from a lower end portion of the wheel side tube to an inside of the vehicle body side tube;
a reservoir partitioned outside the cylinder and configured to store hydraulic oil;
a rod extending from an upper end portion of the vehicle body side tube to an inside of the cylinder, the rod being a tubular member configured to allow the hydraulic oil to pass therethrough, and the rod having, at an upper portion thereof, an opening configured to allow the hydraulic oil to be discharged radially outside;
a piston provided at a lower end portion of the rod and partitioning the inside of the cylinder into two oil chambers;
a control valve provided at the upper end portion of the vehicle body side tube, including a valve body that is located on a center line of the rod and displaceable along the center line, and configured to apply flow path resistance to the hydraulic oil flowing from the opening of the rod to the reservoir by a displacement of the valve body; and
a guide member located between an upper end of the rod and the control valve and on the center line of the rod, and including an oil inlet located radially outside an outer peripheral surface of the rod and configured to introduce the hydraulic oil from the opening of the rod, an oil outlet configured to lead out the hydraulic oil to the control valve, and a first guide path that guides the hydraulic oil introduced from the oil inlet to the oil outlet.

2. The hydraulic shock absorber according to claim 1, wherein
the guide member further includes a second guide path that guides the hydraulic oil flowing from the control valve to the reservoir,
the first guide path extends in a longitudinal direction of the rod, and
the second guide path extends in a radial direction of the rod and is separated from the first guide path.

3. The hydraulic shock absorber according to claim 2, wherein
the guide member includes an annular groove formed over an entire circumference of an outer peripheral surface, and
the annular groove communicates with the second guide path.

4. The hydraulic shock absorber according to claim 2, wherein
the oil outlet is located radially outside the control valve.

5. The hydraulic shock absorber according to claim 1, wherein
the guide member includes a seal member that seals between the reservoir and an accommodating chamber that stores the control valve.

6. The hydraulic shock absorber according to claim 1, wherein
at least a part of the control valve is fitted into the guide member.

7. The hydraulic shock absorber according to claim 1, further comprising:
a check valve configured to allow only a flow of the hydraulic oil flowing from the opening of the rod to the control valve.

8. The hydraulic shock absorber according to claim 1, wherein
the first guide path includes a horizontal hole-shaped first passage extending from the oil inlet in a direction intersecting the center line of the rod, and a vertical hole-shaped second passage extending from the first passage to the oil outlet, and
the second passage is located on the center line of the rod.
